(19) United States
(12) Patent Application Publication
(10) Pub. No.: US 2009/0088180 A1
(43) Pub. Date: Apr. 2, 2009

(54) COMPUTING GEOGRAPHICAL LOCATION OF A MOBILE RECEIVER USING NETWORK MEASUREMENT REPORTS

(76) Inventors: James LaMance, Hixson, TN (US); David Albert Lundgren, Mill Valley, CA (US)

Correspondence Address: MCANDREWS HELD & MALLOY, LTD, 500 WEST MADISON STREET, SUITE 3400, CHICAGO, IL, 60661, US

(21) Appl. No.: 11/865,414

(22) Filed: Oct. 1, 2007

(51) Int. Cl. H04Q 7/34

(52) U.S. Cl. 455/456.1

(57) ABSTRACT

A method and an apparatus for determining a location of a mobile receiver including the steps of measuring a plurality of signal strengths received by a mobile receiver, wherein the plurality of signal strengths are associated with a plurality of cellular stations, wherein the plurality of signal strengths is associated with a specific point in time, combining the plurality of signal strengths with a plurality of signal path modeling parameters to create a propagation path loss model of the path between the plurality of cellular stations and the mobile receiver, applying a non-linear estimation algorithm to the propagation path loss model, generating a plurality of distances, wherein each distance is associated with the mobile receiver and each of the plurality of cellular stations and computing the location of the mobile receiver by iterating the non-linear estimation algorithm and resulting mobile receiver position until converged.

### BACKGROUND OF THE INVENTION

1. Field of the Invention

The present invention generally relates to mobile cellular receivers and, more particularly, to a method and system for computing a geographical location of the mobile receiver using at least one network measurement report.

2. Description of the Related Art

A number of different types of location-based service applications have been developed or proposed for wireless telecommunications networks, i.e., communications networks involving at least one wireless interface between communicating devices. Generally, such applications determine or otherwise obtain location information regarding the location of a mobile receiver under consideration, e.g., a wireless telephone, PDA, wireless data terminal or the like, and provide service information based on the mobile receiver location. Examples of location-based service applications include E911, local service information and location-based billing applications. In E911 applications, emergency calls are routed to a selected dispatcher based on the location of origin of an emergency call. Additionally, location information may be transmitted to the dispatcher or another location to assist in the emergency response. Location-based service applications provide information regarding local services such as hotels or restaurants based on a request entered via a mobile receiver. In location-based billing applications, a rate for a call placed or received by a wireless telephone is dependent on the location of the phone, e.g., whether the phone is inside or outside of a “home zone” for the subscriber proximate to the subscriber's residence, business or other defined location. Various other applications have been proposed or implemented.

Location-based service applications generally involve comparing a current (or recent) location to a location of interest, e.g., a point identified by geographical coordinates, a boundary, or a predefined service zone definition, to make a binary determination (e.g., that the mobile receiver is either inside or outside of a zone under consideration), a matching determination (e.g., that the mobile receiver location matches or overlaps one or more stored zone definitions), or a proximity determination (e.g., to identify the closest service provider(s)). In any case, at one or more relevant processing steps, mobile receiver location information corresponding to a particular time is compared to service location information corresponding to one or more service zones, service provider locations or other stored location information. Thus, in E911 applications the mobile receiver location at the time of placing an E911 call may be compared to the dispatcher coverage zones of an emergency response network. In local service information applications, the location of a mobile receiver at the time of submitting, for example, a local hotel information request, may be compared to a database of hotel location information. The location of a mobile receiver during a call may be used by a location-based billing application to establish billing parameters for the call.

In addition, location-based service applications generally provide service information in response to an input by a subscriber or other application user invoking the application. In the case of local service information applications, the input is generally an explicit service request entered via the mobile receiver. In E911 or location-based billing applications, the location-based service application may be invoked invisibly, from the perspective of the mobile receiver, upon making a call. In other cases, the input invoking the application to provide service information based on the location of the mobile receiver is received from a separate application. In such applications, the service information is nonetheless provided in response to an input requesting location-based services. That is, the trigger event generally is, from the perspective of the service application, a service request.

In some cases today, multiple sources of location information are available. For example, within certain areas of existing networks, a network-based Location Determination Technology (LDT), such as, for example, Position Determination Equipment (PDE) or a Serving Mobile Location Center (SMLC), is available to locate mobile receivers. Such network-based equipment often utilize a multilateration technology, such as time difference of arrival of a signal from the mobile receiver or an angle of arrival to locate a unit based on signals transmitted between the mobile receiver and multiple equipment sites having known locations, such as cell stations. Some mobile receivers are equipped with Global Positioning System (GPS) receivers that can determine the position of the unit based on signals from satellites of the GPS constellation. However, the accuracy of the GPS location determination can degrade in urban areas, that is, areas with multiple buildings and structures that interfere with the signal path between the GPS satellites and the mobile receiver.

Alternately, location information may be available from the network itself, e.g., information that is used to route calls, manage cell-to-cell handoff or otherwise operate the network. For example, such information may include a cell station, cell sector or other network subdivision identifier (“Cell ID”) or handoff information residing in the network for the purposes of handoff management such as Network Measurement Report (NMR) and Mobile Assisted Hand-Off (MAHO) information. Specifically, the NMR is generated by software in the mobile receiver from data collected by the receiver measuring signals received from a base cell station and neighboring cell stations to generate a Received Signal Strength Indicator (RSSI) for each station. Each RSSI is coupled to the Cell ID for each station to create the NMR, which is transmitted to the network using the measurement reporting scheme specified in the system. Based on the NMR, the network can determine the location of a specific mobile receiver. However, the accuracy of the NMR-based location can be limited.

Therefore, there is a need in the art for a method and system for determining the location of a mobile receiver with increased accuracy.

### SUMMARY OF THE INVENTION

Embodiments of the present invention comprise a method and apparatus for determining a location of a mobile receiver. In one embodiment, a plurality of signal strengths received by a mobile receiver is measured, wherein the plurality of signal strengths are associated with a plurality of cellular stations, wherein the plurality of signal strengths is associated with a specific point in time. The plurality of signal strengths is combined with a plurality of signal path modeling parameters to create a propagation path loss model of the path between the plurality of cellular stations and the mobile receiver. A non-linear estimation algorithm is applied to the propagation path loss model. A plurality of distances is generated, wherein each distance is associated with the mobile receiver and each of the plurality of cellular stations. The location of the mobile receiver is computed by iterating the non-linear estimation algorithm and resulting mobile receiver position until converged. The locations of the mobile receiver may be provided to a location server via a telecommunications network.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a system for computing a location of a mobile receiver, in accordance with an embodiment of the present invention;

FIG. 2 presents a method for computing a location of a mobile receiver in accordance with an embodiment of the present invention; and

FIG. 3 presents a method for processing a network measurement report to compute a location of a mobile receiver, in accordance with one embodiment of the present invention;

### DETAILED DESCRIPTION

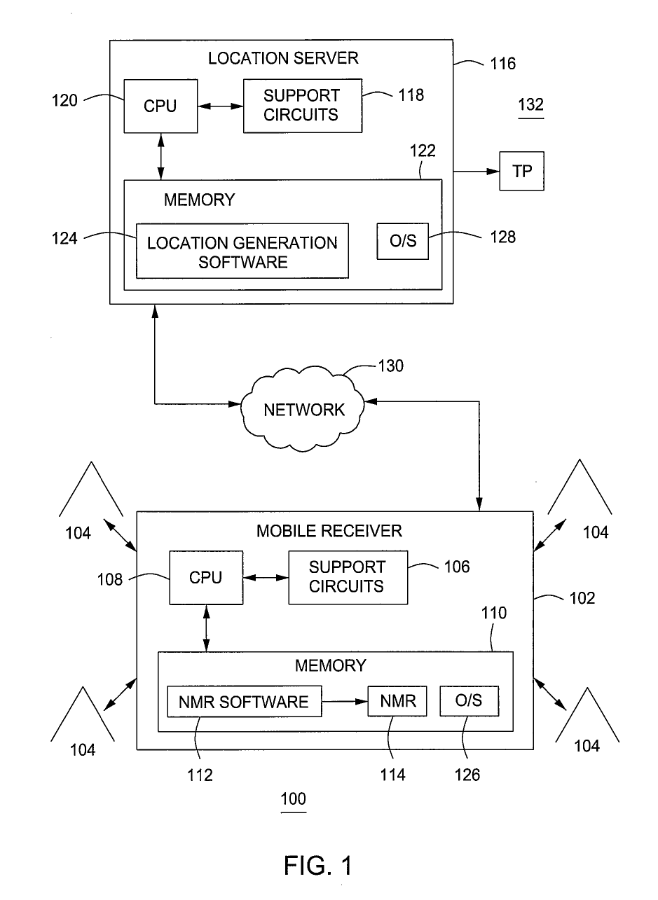

FIG. 1 depicts a system comprising a mobile receiver 102 and at least one location server 116. The mobile receiver 102 comprises a central processing unit (CPU) 108, support circuits 106, and a memory 110. The location server 116 comprises a CPU 120, support circuits 118, and a memory 122. The CPU 108, 120 may comprise one or more conventionally available microprocessors. The support circuits 106, 118 are well known circuits that comprise power supplies, clocks, input/output interface circuitry, and the like. The mobile receiver 102 may include any device that is capable of communicating with a wireless network, such as, for example, a mobile cellular telephone, a handset, a personal digital assistant (PDA), a portable, laptop, notebook, or other computer; a pager, or a telematics device.

Memory 110, 122 may comprise random access memory, read only memory, removable disk memory, flash memory, and various combinations of these types of memory. The memory 110, 122 is sometimes referred to as main memory and may in part be used as cache memory or buffer memory. The memory 110, 122 stores various software packages and components, such as an operating system (O/S) 126, 128. Although FIG. 1 depicts one location server 116 in system 100, other embodiments of the present invention include systems with multiple location servers.

Memory 110 of the mobile receiver 102 may comprise a software application 112 with functionality for generating at least one Network Measurement Report (NMR) 114, which may be stored internally in memory 110. In an alternate embodiment, the NMR 114 is stored in a database (not shown), external to the mobile receiver 102. The NMR is generated from information and data received from the cellular stations 104, via wireless communications.

The mobile receiver 110 then transmits the NMR 114 to the location server 116 via a communications network 130, preferably a telecommunications network. Alternately, the communications network 130 may be any conventional network, such as an Ethernet network, a fiber channel network, or a wide area network (WAN) that provides either a direct or indirect (e.g., Internet via a wired or wireless connection, or public switched telephone network (PSTN)) connection.

Memory 122 of the location server 116 comprises a software application 124 for generating location data associated with the mobile receiver 102 using the received NMR 114. The location server 116 may then transmit the location data to the mobile receiver 102 through the network 130. In another embodiment of the present invention, the location server 116 may transmit the location data to a third party (TP) 132 upon request.

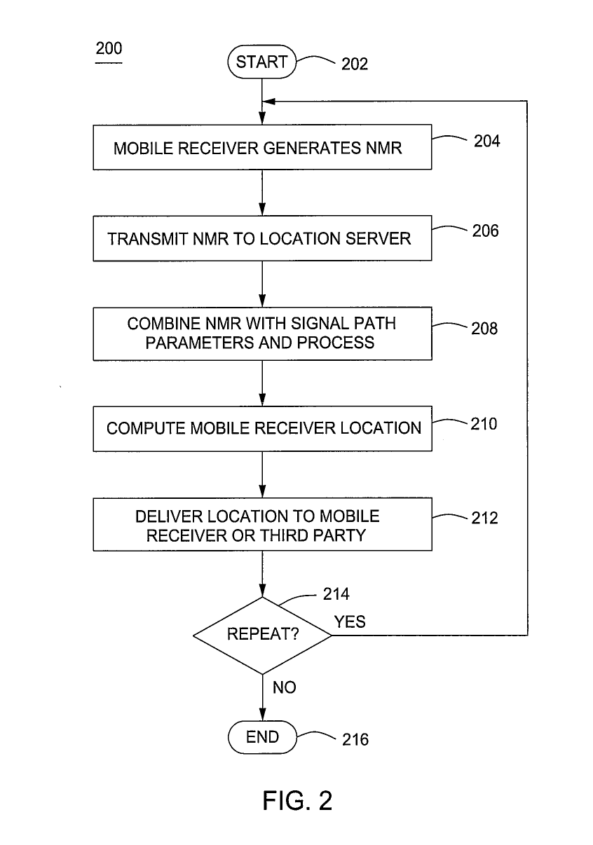

FIG. 2 provides a method for computing the location of a mobile receiver, according to an embodiment of the present invention. The steps need not be in the sequence illustrated, and some of the steps may be essentially simultaneous. Method 200 begins at step 202 and continues with a mobile receiver, such as mobile cellular phone, generating an NMR based on a plurality of cellular stations, at step 204. The NMR may comprise information associated with each cellular station, such as a unique station identifier and a received signal strength indicator (RSSI) associated with each cellular station. The NMR may be generated by a software application located in the mobile receiver.

At step 206, the mobile receiver transmits the NMR to at least one location server over a communications network. At step 208, the location server receives the NMR and combines the NMR with a plurality of signal path modeling parameters associated with the mobile receiver and with the plurality of cellular stations. The location server then processes the NMR to compute a geographical location of the mobile receiver, at step 210.

The location server delivers the computed location to the mobile receiver for use by a user, or perhaps to some other third party, at step 212. The mobile receiver then determines whether the method should be repeated, at step 214. The method may be repeated, for example, if the mobile receiver is moving and not stationary, such that periodic location computations would be of use to a moving user. If the method is to be repeated, the method restarts at step 204. If the method is not to be repeated, the process ends at step 216.

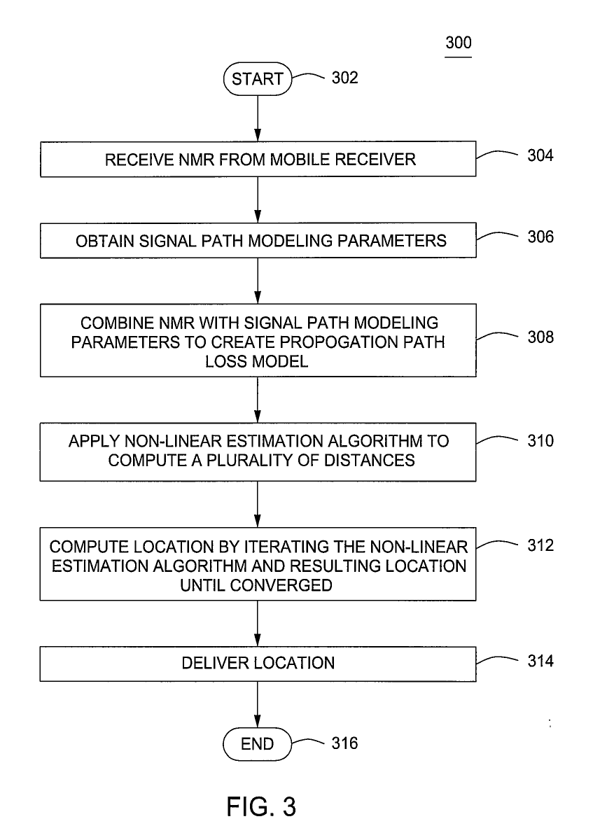

In FIG. 3, the processing of a NMR to compute a location of a mobile receiver is described further. The method 300 starts at step 302 and continues to the location server obtaining an NMR at any given time from a mobile receiver. As previously stated, the NMR comprises information regarding a plurality of cellular stations within a certain geographical region of the mobile receiver's location. Such information includes a cellular station identifier and a RSSI for each cellular station. A software application maintained by the location server receives the NMR in order to compute the location of the mobile receiver. The RSSI is a received signal strength value generated from the power strength of the signal measured between the transmit signal power (P_{T}) from the mobile receiver to the cellular station, and the return signal power (P_{R}) to the mobile receiver from the cellular station. Based on the RSSI, a distance between the mobile receiver and the cellular station may be computed and incorporated into computing a location of the mobile receiver.

However, to compute an accurate location and to take into account environmental conditions of the mobile receiver's location, such as, for example, topographical features, urban features, such as man-made structures and city layouts, etc., at step 306, the location server obtains other cellular station data, such as, a location for each cellular station, man-made structures and topographical features surrounding the location of each cellular station, a cellular station antenna height, a cellular station antenna direction, an effective radiated power of each cellular station, and a frequency for each cellular station, antenna sector data, antenna gain pattern modeling, relative height-above-ground difference between the mobile receiver and a transmitter located at each cellular station, and antenna beamwidth. Such data may be previously provided to the location server by an external source, such as the location of the cellular station, and antenna information associated with the cellular station, while other data, such as the relative height above ground distance between the mobile receiver and the cellular station transmitter, is obtained contemporaneously with the NMR. Such data is labeled “signal path modeling parameters,” as the location server uses such parameters to map out the signal path between the mobile receiver and a specific cellular station. In one embodiment of the present invention, the signal path modeling parameters further comprise parameters associated with an urban path loss model, such as, for example, urban structural features associated with each cellular station. In another embodiment, the signal path modeling parameters further comprise parameters associated with a path terrain model, such as, for example, terrain data and environmental features surrounding each cellular station.

At step 308, the location server application combines the NMR data and the signal path modeling parameters to create a propagation path loss model. The path loss model is generated to substantially mimic the signal path traveled between the mobile receiver and a specific cellular station.

The location server application then applies a non-linear estimation algorithm to the path loss model to compute a distance associated with a specific cellular station in relation to the mobile receiver, at step 310. As information associated with multiple cellular stations is included in the NMR, the location server application computes a plurality of distances, wherein each distance is related to each cellular station. In an embodiment of the present invention, the location server application applies the Downhill Simplex algorithm to the path loss model to compute a location of the mobile receiver.

At step 312, the location server application computes a location of the mobile receiver using the plurality of distances computed in step 310 by iterating the non-linear estimation algorithm and resulting mobile receiver location until converged. The non-linear estimation algorithm is employed because the geometry and non-linear characteristics of the range models may cause certain GPS iterative positioning techniques to operate inadequately. During the application of the non-linear estimation algorithm, the receiver position is moved to find the location that minimizes the effects of variances in the ranges derived from the models. Hence, iteration of the non-linear estimation algorithm results in convergence of the ranges. In one embodiment of the present invention, the location of the mobile receiver is computed by applying a triangulation algorithm to the plurality of distances if there is an equal number of observations and variables.

At step 314, the location server may deliver the computed location to the mobile receiver or an outside third party, via a communications network, such as a wireless telecommunications network. The method then ends at step 316. Test examples applying method 300 produced a geographic location for a mobile receiver with an accuracy of about 91 percent within a 150-meter radius of the mobile receiver, and an accuracy of about 100 percent within a 300-meter radius of the mobile receiver.

In yet another embodiment of the present invention, the method further comprises obtaining multiple NMRs, including multiple RSSIs associated with a group of cellular stations over a period of time, to provide information for computing the location of a mobile receiver as it is continuously moving, for example, if a user is driving and desires to obtain his/her location using his/her mobile cellular phone.

Another embodiment of the present invention provides a method for computing a location of a mobile receiver further comprising the step of obtaining geographical location data from a global positioning system (GPS) associated with the mobile receiver, and combining the GPS position data with the computed plurality of distances to produce an improved location for the mobile receiver.

Another embodiment of the present invention provides a method for computing a location of a mobile receiver further comprising repeating the application of the non-linear estimation algorithm to a set of signal path modeling parameters, discarding at least one outlier computed distance, and computing a location of the mobile receiver without the at least one outlier distance to produce an improved location.

While the foregoing is directed to embodiments of the present invention, other and further embodiments of the invention may be devised without departing from the basic scope thereof, and the scope thereof is determined by the claims that follow.

1. A method for determining a location of a mobile receiver, the method comprising:
measuring a plurality of signal strengths received by a mobile receiver, wherein the plurality of signal strengths are associated with a plurality of cellular stations, wherein the plurality of signal strengths is associated with a specific point in time;
combining the plurality of signal strengths with a plurality of signal path modeling parameters to create a propagation path loss model of the path between the plurality of cellular stations and the mobile receiver;
applying a non-linear estimation algorithm to the propagation path loss model;
generating a plurality of distances, wherein each distance is associated with the mobile receiver and each of the plurality of cellular stations; and
computing the location of the mobile receiver by iterating the non-linear estimation algorithm and resulting mobile receiver position until converged.

2. The method of claim 1, wherein the plurality of signal path modeling parameters comprises one or more of: a location for each cellular station, a cellular station antenna height, a cellular station antenna direction, an effective radiated power of each cellular station, and a frequency for each cellular station, antenna sector data, antenna gain pattern modeling, relative height-above-ground difference between the mobile receiver and a transmitter located at each cellular station, urban path loss parameters, path terrain model parameters including terrain data and environmental features associated with each cellular station, urban structural features associated with each cellular station, or antenna beamwidth.

3. The method of claim 1, wherein the non-linear estimation algorithm is a Downhill Simplex algorithm.

4. The method of claim 1, wherein the step of computing the location further comprises applying a triangulation algorithm to the plurality of distances between the mobile receiver and each of the plurality of cellular stations.

5. The method of claim 1, wherein the mobile receiver is a mobile cellular phone.

6. The method of claim 1, further comprises obtaining the plurality of signal strengths and the plurality of cellular station identifiers from a network measurement report.

7. The method of claim 6, further comprising obtaining the network measurement report from the mobile receiver.

8. The method of claim 7, further comprising receiving the network measurement report through a communications network.

9. The method of claim 1, further comprising obtaining multiple pluralities of signal strengths over a period of time.

10. The method of claim 9, further comprising computing a first improved geographical position.

11. The method of claim 1, further comprising obtaining geographical location data from a global positioning system, wherein the geographical location data is associated with the mobile receiver and a plurality of global positioning satellites.

12. The method of claim 11, further comprising combining the geographical location data with the computed geographical location to produce a second improved geographical location.

13. The method of claim 1, further comprising transmitting the location to the mobile receiver.

14. The method of claim 1, further comprising transmitting the location to a third party.

15. The method of claim 1, further comprising:
performing the multiple applications of the non-linear estimation algorithm;
discarding at least one outlier computed distance; and
computing a third improved geographical location of the mobile receiver.

16. A method for determining a location of a mobile receiver, the method comprising:
obtaining a network measurement report, wherein the network measurement report comprises a plurality of signal strengths associated with a plurality of cellular stations;
combining the network measurement report with a plurality of signal path modeling parameters to create an urban path loss model;
applying a Downhill Simplex algorithm to the urban path loss model;
generating a plurality of distances, wherein each distance is associated with the mobile receiver and each of the plurality of cellular stations; and
computing the location of the mobile receiver.

17. A system for determining a location of a mobile receiver, the system comprising:
a plurality of cellular stations;
a mobile receiver for determining a plurality of signal strengths associated with the plurality of cellular stations, wherein the plurality of signal strengths are associated with a specific point in time; and
a location server for computing a plurality of signal path modeling parameters related to the mobile receiver combining the plurality of signal strengths with the plurality of signal path modeling parameters to create a propagation path loss model, applying a non-linear estimation algorithm to the propagation path loss model, generating a plurality of distances, wherein each distance is associated with the mobile receiver and each of the plurality of cellular stations; and computing the location of the mobile receiver by iterating the non-linear algorithm and the location computation; and
a network for communications between the mobile receiver and the location server.

18. The system of claim 17, wherein the mobile receiver is a mobile cellular phone.

19. The system of claim 17, wherein the first software application combines the plurality of signal strengths and the plurality of cellular station identifiers to create a network measurement report.

20. The system of claim 17, wherein the network is a wireless telecommunications network.

21. The system of claim 19, wherein the mobile device comprises a global positioning system component capable of providing location information for the mobile device.
